(19) United States
(12) Patent Application Publication
(10) Pub. No.: US 2023/0174775 A1
(43) Pub. Date: Jun. 8, 2023

(54) MOLDED ARTICLE HAVING REDUCED BIREFRINGENCE

(71) Applicants: Hyundai Motor Company, Seoul (KR); Kia Corporation, Seoul (KR); LOTTE CHEMICAL CORPORATION, Seoul (KR)

(72) Inventors: Jung Gyun Noh, Seongnam (KR); Jin Gi Ahn, Seoul (KR); Dae Sik Kim, Yongin (KR); Jung Eun Park, Uiwang (KR); Se Mi Kim, Uiwang (KR); Won Ko, Uiwang (KR)

(21) Appl. No.: 17/983,065

(22) Filed: Nov. 8, 2022

(30) Foreign Application Priority Data
Dec. 3, 2021 (KR) 10-2021-0171460

(51) Int. Cl. C08L 67/02; C08L 69/00

(52) U.S. Cl. CPC C08L 67/02; C08L 69/00; C08L 2207/04

(57) ABSTRACT

Disclosed is a molded article, and more particularly a molded article for a vehicle interior material including a thermoplastic resin composition having reduced birefringence while maintaining the superior transmittance and impact strength of existing polycarbonate resin by including a first resin including a polycarbonate resin and a second resin having a difference in refractive index of 0.05 or less from the first resin and a transmittance of 90% or more.

### CROSS-REFERENCE TO RELATED APPLICATION

This application claims under 35 U.S.C. § 119(a) the benefit of priority from Korean Patent Application No. 10-2021-0171460, filed on Dec. 3, 2021, the entire contents of which are incorporated herein by reference.

### TECHNICAL FIELD

The present invention relates to a resin composition for a molded article, a molded article including the same, and a molded article for a vehicle interior material. The resin composition may include a thermoplastic resin composition imparted with reduced birefringence and include mixing a first resin including a polycarbonate resin with an appropriate amount of a second resin having a specific refractive index and transmittance.

### BACKGROUND

In general, glass is mainly used as a display cover for automobile interior parts. However, glass applied as a display cover is heavy and vulnerable to impact, and is difficult to form into a curved structure, which is undesirable.

Accordingly, attempts have been made to manufacture a display cover using a resin that has a superior refractive index and superior transmittance and is capable of being injection molded.

Polycarbonate resin is advantageous because of the superior heat resistance, transparency, and impact strength thereof, but is problematic in that optical properties are deteriorated due to the occurrence of birefringence.

This birefringence is related to residual stress, and during an injection-molding process, a high-temperature resin is injected into a mold at a high speed under high pressure, and as the high-temperature resin cools over time, a history of heat and pressure remains in the product, resulting in the formation of birefringence.

Meanwhile, in order to solve the problem of birefringence of polycarbonate resin, when an additive is added to the polycarbonate resin simply to improve flow or when a resin having negative birefringence is mixed therewith, there is a problem in that impact strength is lowered. Furthermore, due to low compatibility between the mixed resin and the polycarbonate resin, haze is increased, which is undesirable.

When a polycarbonate copolymer is used, heat resistance, which is an inherent advantage of polycarbonate, is lowered. Since polymethyl methacrylate (PMMA) resin has low birefringence but low impact strength, it is not suitable for use in display covers for automobile interior parts requiring impact strength.

The development of a thermoplastic resin composition capable of being applied to automobile interior parts by reducing birefringence while maintaining superior transmittance and impact strength has been continuously underway.

### SUMMARY

In preferred aspects, provided are a resin composition and a molded article including the resin composition for a vehicle interior material. The resin composition may include a thermoplastic resin composition having reduced birefringence and having the superior transmittance and impact strength of existing polycarbonate resin.

The objects of the present invention are not limited to the foregoing. The objects of the present invention will be able to be clearly understood through the following description and to be realized by the means described in the claims and combinations thereof.

In an aspect, provided is a resin composition for a molded article, and the resin composition may include a first resin including a polycarbonate resin and a second resin having a difference in refractive index of about 0.05 or less than the first resin and a transmittance of about 90% or greater.

The first resin and the second resin may be the same or different type. In certain aspect, the first and second resins are different, these resins are different in physical or chemical properties such as polydispersity index (PDI), refractive index For example, the first resin has the PDI value different from the PDI value of the second resin by at least 5, 10, 20, 25, 30, 35, 40, 45, 60, 70, 80 or 90%, the first resin has the refractive index different from the refractive index value of the second resin by at least 5, 10, 20, 25, 30, 35, 40, 45, 60, 70, 80 or 90%, or the first resin has a transmittance value of the second resin by at least 5, 10, 20, 25, 30, 35, 40, 45, 60, 70, 80 or 90%.

The resin composition may include an amount of about 70 to 90 wt % of the first resin and an amount of about 10 to 30 wt % of the second resin, all wt % are based on the total weight of the resin composition.

The first resin may have a weight average molecular weight (Mw) of about 20,000 to 35,000 g/mol.

The first resin may have a refractive index of about 1.0 to 2.0.

The second resin may include a polyester resin including a dicarboxylic acid component and a diol component. Preferably, the second resin may include a polyester resin obtained by polymerizing a dicarboxylic acid component and a diol component. The dicarboxylic acid component may suitably include one or more selected from the group consisting of terephthalic acid (TPA), dimethyl terephthalate, isophthalic acid (IPA), dimethyl isophthalate, 1,4-cyclohexanedicarboxylic acid, hexahydrophthalic anhydride, 2,6-naphthalenedicarboxylic acid, phthalic anhydride, maleic anhydride, and fumaric anhydride and the diol component may suitably include neopentyl glycol (NPG), 1,4-cyclohexane dimethanol (CHDM), and combinations thereof.

In an aspect, provided is a molded article including the resin composition. The molded article may be formed from polymerization of the resin composition, e.g., by curing, heating, or UV radiation.

The molded article may have a heat deflection temperature of about 116 to 118° C. measured according to ASTM D648.

The molded article may have a transmittance of about 90 to 94% measured according to ASTM D1003.

Preferably, in the molded article, the absolute value of an optical path difference of photoelastic fringes between a portion having maximum residual stress and a portion having minimum residual stress may be about 400 or less.

In an aspect, provided is a vehicle interior component including the molded article as described herein.

Also provided is a vehicle including the molded article as described herein.

### DETAILED DESCRIPTION

The above and other objects, features and advantages of the present invention will be more clearly understood from the following preferred embodiments taken in conjunction with the accompanying drawings. However, the present invention is not limited to the embodiments disclosed herein, and may be modified into different forms. These embodiments are provided to thoroughly explain the disclosure and to sufficiently transfer the spirit of the present invention to those skilled in the art.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof.

Unless otherwise specified, all numbers, values, and/or representations that express the amounts of ingredients, reaction conditions, and compositions used herein are to be taken as approximations including various uncertainties affecting measurement that inherently occur in obtaining these values, among others, and thus should be understood to be modified by the term “about” in all cases. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

A resin composition for a molded article may include a first resin including a polycarbonate resin and a second resin having a difference in refractive index of about 0.05 or less than the first resin and a transmittance of about 90% or greater. Preferably, the molded article may suitably include an amount of about 70 to 90 wt % of the first resin and an amount of about 10 to 30 wt % of the second resin. The amount of each component of the thermoplastic resin composition, “wt %”, to be described below is based on 100 wt % of the thermoplastic resin composition. If the basis therefor is changed, the changed basis will always be specified, so those of ordinary skill in the art will be able to clearly know what composition the amount is based on.

Each component constituting the thermoplastic resin composition and the molded article according to the present invention is described in more detail below.

(A) First Resin

The first resin may be a basic raw material of the thermoplastic resin composition, and may be a resin having superior transmittance and impact strength.

The first resin may preferably include a polycarbonate resin. The first resin may be included in an amount of about 70 to 90 wt % based on the total amount of the thermoplastic resin composition. When the amount of the first resin is less than about 70 wt %, the thermoplastic resin composition may not have superior impact strength.

The first resin may have a weight average molecular weight (Mw) of about 20,000 to 35,000 g/mol. When the weight average molecular weight (Mw) of the first resin is less than about 20,000 g/mol, mechanical properties such as impact strength and the like may be deteriorated, The first resin may suitably have a refractive index of about 1.0 to 2.0. Particularly, the refractive index of the first resin may be about 1.585.

(B) Second Resin

The second resin may be included to offset the birefringence properties of the polycarbonate resin in the thermoplastic resin composition.

The second resin may have a specific refractive index and transmittance. The refractive index of the second resin may have a difference of about 0.05 or less than the refractive index of the first resin, and particularly, the refractive index thereof may be about 1.535 to 1.635. The transmittance of the second resin may be about 90% or greater.

The second resin may be included in an amount of about 10 to 30 wt % based on the total amount of the thermoplastic resin composition. When the amount of the second resin is less than about 10 wt % or greater than about 30 wt %, the effect of reducing the birefringence of the thermoplastic resin composition may be insignificant.

The second resin may include a polyester resin including a dicarboxylic acid component and a diol component. The polyester resin may be prepared or obtained by polymerizing a dicarboxylic acid component and a diol component. The dicarboxylic acid component may include one or more selected from the group consisting of terephthalic acid (TPA), dimethyl terephthalate, isophthalic acid (IPA), dimethyl isophthalate, 1,4-cyclohexanedicarboxylic acid, hexahydrophthalic anhydride, 2,6-naphthalenedicarboxylic acid, phthalic anhydride, maleic anhydride, and fumaric anhydride. The diol component may include neopentyl glycol (NPG), 1,4-cyclohexane dimethanol (CHDM), and combinations thereof.

Also, provided is a molded article made of the resin composition as described herein. The molded article may be obtained by molding the thermoplastic resin composition through a process such as extrusion molding, injection molding, compression molding, foam injection molding, foaming low-pressure injection molding, gas compression molding, or the like.

The molded article is not limited with regard to the field of use thereof, but may be applied to a molded article in a field in which properties related to not only transmittance and impact strength but also birefringence are important. For example, it is preferably applied to display covers for automobile parts, mechanical parts, electrical and electronic parts, office equipment such as computers, and miscellaneous goods.

The molded article may have a heat deflection temperature of about 116 to 118° C. measured according to ASTM D648. The molded article may have a transmittance of about 90 to 94% measured according to ASTM D1003. In the molded article, the absolute value of the optical path difference of photoelastic fringes between a portion having maximum residual stress and a portion having minimum residual stress may be about 400 or less.

### EXAMPLE

A better understanding of the present invention may be obtained through the following examples. These examples are merely set forth to illustrate the present invention, and are not to be construed as limiting the present invention.

### Examples 1 to 3 and Comparative Examples 1 to 4

Respective thermoplastic resin compositions were prepared using components in the amounts shown in Table 1 below.

TABLE 1

| | | | | | Comparative | Comparative | Comparative | Comparative |
|---|---|---|---|---|---|---|---|---|
| Component (wt %) | | Example 1 | Example 2 | Example 3 | Example 1 | Example 2 | Example 3 | Example 4 |
| First | PC-1 | 70 | 85 | 90 | — | 80 | 80 | 100 |
| resin | PC-2 | — | — | — | 80 | — | — | — |
| Second | Co- | 30 | 15 | — | 20 | — | — | — |
| resin | polyester-1 | | | | | | | |
| | Co- | — | — | 10 | — | — | — | — |
| | polyester-2 | | | | | | | |
| Additive | PS | — | — | — | — | 20 | — | — |
| | PMMA | — | — | — | — | — | 20 | — |
| | Flow | — | — | — | — | — | | 3 |
| | enhancer | | | | | | | |

| | | | | | | | |
|---|---|---|---|---|---|---|---|
| Total | 100 | 100 | 100 | 100 | 100 | 100 | 103 |

[Components of composition]
(1) First resin
PC-1: Polycarbonate resin having a weight average molecular weight (Mw) of 20,000 to 35,000 g/mol
PC-2: Polycarbonate resin having a weight average molecular weight (Mw) of less than 20,000 g/mol
(2) Second resin (refractive index of 1.535 to 1.635 and transmittance of 90% or more)
Co-polyester-1: Copolymer in which the diol component of polyester is modified with 1,4-cyclohexanedimethanol (CHDM)
Co-polyester-2: Copolymer in which the diol component of polyester is modified with neopentyl glycol (NPG)
(3) Additive
PS: Polystyrene resin, Formosa Chemicals & Fiber TAIRIREX GP-5000
PMMA: Polymethyl methacrylate resin, LG MMA LF850
Flow enhancer: Phenoxyphosphazene oligomer that lowers the glass transition temperature (Tg) of polycarbonate resin

### TEST EXAMPLES

The thermoplastic resin compositions prepared in Examples 1 to 3 and Comparative Examples 1 to 4 were manufactured into specimens for measuring physical properties, and the physical properties thereof were measured through the following evaluation methods. The results thereof are shown in Table 2 below.

Here, the specimens thus manufactured were molded articles obtained by mixing components and additives using a Hensel mixer, a V blender, a tumbler blender, a ribbon blender, or the like and melt-extruding the mixture using a single-screw extruder or a twin-screw extruder to form pellets, which were then subjected to injection molding.

Evaluation Method

(1) Unnotched IZOD impact strength: In accordance with ASTM D4812, whether or not a 3.2 mm-thick specimen was destroyed was observed.

(2) HDT (heat deflection temperature, unit: ° C.): A heat deflection temperature was measured under a load of 1.8 MPa in accordance with ASTM D648.

(3) Birefringence: Using an analyzer, the presence or absence of birefringence based on photoelastic fringes was determined based on A and B described below.
A: When a specimen having a size of 100 mm×100 mm×3.2 mm was placed on a strain viewer and measured, the absolute value of the optical path difference of photoelastic fringes between a portion having maximum residual stress and a portion having minimum residual stress was 400 or less.
B: When a specimen having a size of 100 mm×100 mm×3.2 mm was placed on a strain viewer and measured, the absolute value of the optical path difference of photoelastic fringes between a portion having maximum residual stress and a portion having minimum residual stress was more than 400.

Here, the analyzer was an HKL-MSV available from HK Lab, and the measured values were substituted into Equation 1 below to obtain the optical path difference of photoelastic fringes.

Optical path difference of photoelastic fringes(nm)=N(cycle number)×λ(main wavelength)+(λ(main wavelength)×(extinction angle/180)) [Equation 1]

(In Equation 1, the cycle number represents the repeat position of a strain pattern, and is as shown in 1) to 4) below.

1) Cycle 0: 1^{st} Black to 1^{st} Red (1^{st} order color)

2) Cycle 1: 1^{st} Blue to 2^{nd} Red (2^{nd} order color)

3) Cycle 2: 2^{nd} Blue to 3^{rd} Red (3^{rd} order color)

4) Repeat in the same way as above.

Also, in Equation 1, the extinction angle represents the angle at which the measurement position turns black while the analyzer is rotated to the left and right after the angle of the analyzer is set to 0.)

(4) Transmittance (unit: %): The transmittance of a specimen having a size of 100 mm×100 mm×3.2 mm was measured using an NDH-5000 made by Nippon Denshoku Industries in accordance with ASTM D1003.

TABLE 2

| Evaluation | | | | Comparative | Comparative | Comparative | Comparative |
|---|---|---|---|---|---|---|---|
| items | Example 1 | Example 2 | Example 3 | Example 1 | Example 2 | Example 3 | Example 4 |
| Unnotched | Not | Not | Not | Destroyed | Destroyed | Destroyed | Destroyed |
| IZOD | destroyed | destroyed | destroyed | | | | |
| HDT | 116 | 118 | 118 | 116 | 109 | 105 | 110 |
| Birefringence | A | A | A | A | B | B | B |
| Transmittance | 90 | 92 | 94 | 92 | 85 | 77 | 94 |

As shown in Table 2, Comparative Example 1 using a polycarbonate resin having a weight average molecular weight (Mw) of less than 20,000 g/mol was easily destroyed due to the poor impact strength thereof. Therefore, it can be confirmed that the weight average molecular weight (Mw) of the polycarbonate resin affects the impact strength of the thermoplastic resin composition.

In addition, Comparative Example 2 and Comparative Example 3, in which a polystyrene resin and a polymethyl methacrylate resin as respective additives were added to the polycarbonate resin, had relatively poor impact strength, heat deflection temperature, and transmittance compared to Examples, and moreover, birefringence was not reduced.

In addition, Comparative Example 4, in which a flow enhancer was added to the polycarbonate resin, had superior transmittance, but had poor impact strength and heat deflection temperature compared to Examples, and moreover, birefringence was not reduced.

Further, as shown in Table 2, however, Examples 1 to 3 according to exemplary embodiments of the present invention, in which individual components were mixed in appropriate amounts, were not easily destroyed, and had a heat deflection temperature of 116 to 118° C. and a transmittance of 90 to 94%, and the absolute value of the optical path difference of photoelastic fringes between the portion having maximum residual stress and the portion having minimum residual stress was measured to be 400 or less.

Therefore, the thermoplastic resin composition and the molded article according to the present invention have superior impact strength, high heat resistance of 116° C. or greater, and high transmittance of 90% or greater, and simultaneously exhibit low birefringence, thereby providing superior mechanical properties.

According to various exemplary embodiments of the present invention, the molded article can exhibit reduced birefringence while maintaining superior transmittance and impact strength by including a thermoplastic resin composition obtained by mixing a first resin including a polycarbonate resin with an appropriate amount of a second resin having a difference in refractive index of 0.05 or less from the first resin and a transmittance of 90% or more.

Further, according to various exemplary embodiments of the present invention, a molded article may include a thermoplastic resin composition obtained by mixing a first resin including a polycarbonate resin with an appropriate amount of a second resin having a difference in refractive index of 0.05 or less than the first resin and a transmittance of 90% or greater, thereby reducing birefringence while maintaining superior transmittance and impact strength.

The effects of the present invention are not limited to the above-mentioned effects. It should be understood that the effects of the present invention include all effects that can be inferred from the description of the present invention.

Although exemplary embodiments of the present disclosure have been described with reference to the accompanying drawings, those skilled in the art will appreciate that the present disclosure may be embodied in other specific forms without changing the technical spirit or essential features thereof. Thus, the embodiments described above should be understood to be non-limiting and illustrative in every way.

What is claimed is:

1. A resin composition for a molded article, comprising:
a first resin comprising a polycarbonate resin; and
a second resin having a difference in refractive index of about 0.05 or less than the first resin and a transmittance of about 90% or greater.

2. The resin composition of claim 1, comprising:
an amount of about 70 to 90 wt % of the first resin; and
an amount of about 10 to 30 wt % of the second resin,
all wt % are based on the total weight of the molded article.

3. The resin composition of claim 1, wherein the first resin has a weight average molecular weight (Mw) of about 20,000 to 35,000 g/mol.

4. The resin composition of claim 1, wherein the first resin has a refractive index of about 1.0 to 2.0.

5. The resin composition of claim 1, wherein the second resin comprises a polyester resin comprising a dicarboxylic acid component and a diol component,
the dicarboxylic acid component comprises one or more selected from the group consisting of terephthalic acid (TPA), dimethyl terephthalate, isophthalic acid (IPA), dimethyl isophthalate, 1,4-cyclohexanedicarboxylic acid, hexahydrophthalic anhydride, 2,6-naphthalenedicarboxylic acid, phthalic anhydride, maleic anhydride, and fumaric anhydride, and
the diol component comprising neopentyl glycol (NPG), 1,4-cyclohexane dimethanol (CHDM), and combinations thereof.

6. A molded article comprising a resin composition of claim 1.

7. The molded article of claim 6, wherein the molded article has a heat deflection temperature of 116 to 118° C. measured according to ASTM D648.

8. The molded article of claim 6, having a transmittance of about 90 to 94% measured according to ASTM D1003.

9. The molded article of claim 6, wherein an absolute value of an optical path difference of photoelastic fringes between a portion having maximum residual stress and a portion having minimum residual stress is about 400 or less.

10. A vehicle interior component comprising a molded article of claim 6.

11. A vehicle comprising a molded article of claim 6.
